(19) United States
(12) Patent Application Publication
(10) Pub. No.: US 2022/0186722 A1
(43) Pub. Date: Jun. 16, 2022

(54) METHOD FOR DETERMINING THE POSITION OF THE DIAPHRAGM OF AN ELECTRIC-MOTOR-DRIVEN DIAPHRAGM PUMP

(71) Applicant: ebm-papst St. Georgen GmbH & Co. KG, St. Georgen (DE)

(72) Inventors: Marcus HELLMANN, Unterkirnach (DE); David POHL, St. Georgen (DE)

(21) Appl. No.: 17/601,373

(22) PCT Filed: May 15, 2020
(86) PCT No.: PCT/EP2020/063652

§ 371 Date: Oct. 4, 2021

(30) Foreign Application Priority Data
Jul. 1, 2019 (DE) 102019117731.6

(51) Int. Cl. F04B 43/04; F04B 43/00; F04B 49/12

(52) U.S. Cl. CPC F04B 43/04; F04B 2201/1208; F04B 49/125; F04B 43/0081

(57) ABSTRACT

The disclosure relates to a position detection device for determining the position of the diaphragm or the drive piston of an electric-motor-driven diaphragm pump, in particular detecting the upper and lower reversal point (Po, Pu) in the movement curve of the diaphragm of a diaphragm pump operated in an electric-motor-driven manner via eccentric means, wherein a diaphragm actuated by a drive connecting rod closes a conveying chamber with valve means provided on an inlet and outlet side such that the volume can be changed between a minimum and maximum volume, whereby a reciprocating movement of an electric motor having a rotor attached to a shaft is converted into an actuation movement of the drive connecting rod via the effect of the eccentric means, wherein the position detection device has detecting means for detecting the average value position of the rotor shaft, as well as an evaluation device in order to determine at least the position of the upper reversal point of the diaphragm from the average value position.

### RELATED APPLICATIONS

This application is a national stage application that claims priority to PCT/EP2020/063652, filed May 15, 2020, and which claims benefit of German Patent Application No. 10 2019 117 731.6, filed Jul. 1, 2019, the entire contents of which are incorporated herein by reference in their entirety.

### FIELD

The present disclosure relates to a method for determining the position of the diaphragm or the drive piston of an electric-motor-driven diaphragm pump, which is operated in a reciprocating manner, in particular for detecting the upper and lower reversal point in the movement sequence of the diaphragm of such a diaphragm pump.

### BACKGROUND

Diaphragm pumps for conveying liquids or gases are generally known from the prior art.

Various designs of diaphragm pumps are available in the prior art. All diaphragm pump designs relate essentially to a machine for conveying liquids or gases, which is particularly resistant to long-term stress and impurities in the conveyed medium. The functional principle of a diaphragm pump is a modification of the known piston pump, but the medium to be conveyed is separated from the drive unit by a diaphragm. The advantage of this kind of pump is that the separating diaphragm protects the drive unit from harmful influences of the conveyed medium, for example sludge or impurities. This is the particular reason for the ruggedness and low wear of a diaphragm pump that is subjected to long-term stress, which makes such machines well-suited for conveying tasks that have a long operating times and service lives, as is the case for example in the industrial and automotive sectors.

A conventional diaphragm pump has a feed chamber that is closed by a diaphragm and is secured by valves on the inlet and outlet side. The volume of this chamber is changed when a pushing or pulling action is exerted on the diaphragm, causing a suction or compression event to occur and thus a feeding of a fluid to take place in accordance with the valve configuration. The deflection of the diaphragm occurs either hydraulically, pneumatically, mechanically, or electromagnetically.

The present disclosure involves an electric-motor-driven diaphragm pump, i.e. one that is mechanically driven by an electric motor. In most cases, such electric-motor-driven diaphragm pumps are driven by an electric motor via a connecting rod, i.e. a drive piston and an eccentric.

Diaphragm pumps of this generic type have a high torque fluctuation along a rotation direction of the eccentric relative to the motion of the tappet rod or connecting rod along the eccentric drive. German patent DE 102016125578 A discloses a diaphragm pump that is operated in an electric-motor-driven manner via eccentric elements, which uses a particular drive concept of a reciprocating eccentric drive.

In this case, the electric motor that drives the eccentric elements is set into a periodic reciprocating motion, which extends over a particular rotation angle range that is less than a complete rotation of the eccentric elements. Preferably, this rotation angle range is less than 200°, which thus avoids a complete rotation and thus particularly also avoids an operating position that is high relative to the required torque and is therefore undesirable; this range can also be embodied as even smaller if need be.

We have found that in order to be able to control the valve matrix in a selective and efficient way, however, one must be able to determine the precise reversal points in the reciprocating operation.

For the valve positioning, therefore, it is necessary to detect the reversal points of the diaphragm from the suction phase with an increasing feed volume to the compression phase with a decreasing feed volume since an excessively early or excessively late valve actuation results in an inefficient operation. Determining the position of the diaphragm and particularly also the time of the respective top and bottom dead centers of the diaphragm is also required for basic pump control.

### BRIEF SUMMARY

The object of the present disclosure, therefore, is to propose a device and a method, which in a simple and inexpensive way permit a reliable detection of the position of a diaphragm of an electric-motor-driven diaphragm pump in reciprocating operation.

This object is attained by the feature combination according to claim 1.

According to the disclosure, a position detection device for determining the position of the diaphragm or the drive piston of an electric-motor-driven diaphragm pump is provided for this purpose, in particular for detecting the upper and lower reversal point in the movement sequence of the diaphragm of a diaphragm pump that is operated in a reciprocating manner by an electric motor via eccentric elements in which a diaphragm, which is actuated by a drive connecting rod, closes a feed chamber, which is provided with valve elements on the inlet and outlet side such that the volume can be changed between a minimum and maximum volume in that through the action of the eccentric elements, a reciprocating motion of an electric motor with a rotor is converted into an actuating motion of the drive connecting rod, wherein the position detection device has detection means for detecting the average position of the rotor shaft and an evaluation device for determining at least the position of the upper reversal point of the diaphragm from the average position.

Preferably, the reciprocating motion is triggered via the reciprocating motor shaft only after the motor shaft—once the motor has started—first executes a rotary motion and then is switched into the reciprocating motion.

For purposes of the present disclosure, the terms upper and lower reversal point are understood to be the positions of the diaphragm at which the respective movement direction of the diaphragm in its up and down motion switches into the respective opposite direction, thus respectively reducing or increasing the feed volume again in alternating fashion at these points.

In a particularly advantageous embodiment of the disclosure, the detection means are embodied in particular to detect the average position of the motor shaft during a complete up and down motion of the diaphragm once the motor shaft has been switched from a rotary motion into a reciprocating motion.

It is also advantageous that measuring means are provided to detect the position of the rotor of the electric motor; the detection of the rotor position is advantageously performed through the use of an angle gage.

Another aspect of the present disclosure relates to a diaphragm pump that is embodied with a position detection device of the kind described above.

Preferably, it relates to a diaphragm pump with a motor control device, which is embodied to set the rotor shaft into a reciprocating motion in a particular angular range between 150° and 200° and a valve control device for triggering valves as a function of the diaphragm position determined by the position detection device.

Another innovative aspect of the present disclosure relates to a method for determining the position of the diaphragm or the drive piston of an electric-motor-driven diaphragm pump in reciprocating operation, in particular for detecting the upper and lower reversal point in the movement sequence of the diaphragm of a diaphragm pump that is operated in an electric-motor-driven manner via eccentric elements, in which a diaphragm, which is actuated by a drive connecting rod, closes a feed chamber, which is provided with valve elements on the inlet and outlet side such that the volume can be changed between a minimum and maximum volume in that through the action of the eccentric elements, a reciprocating motion of an electric motor with a rotor is converted into an actuating motion of the drive connecting rod, with the provision of the method step such that the position of the diaphragm is determined based on at least the detection of the average position of the motor shaft through the use of an angle gage.

In this case, it is advantageous that the method is carried out with a position detection device of the kind described above.

### BRIEF DESCRIPTION OF THE DRAWINGS

Other advantageous modifications of the disclosure are disclosed in the dependent claims and will be described in greater detail below together with the description of the preferred embodiment of the disclosure based on the figures.

In the drawings:

FIG. 1 shows a diagram, which depicts by way of example the position of the shaft plotted over time and

FIG. 2 is a flowchart, which shows the steps for determining the turning points according to the disclosure.

### DETAILED DESCRIPTION

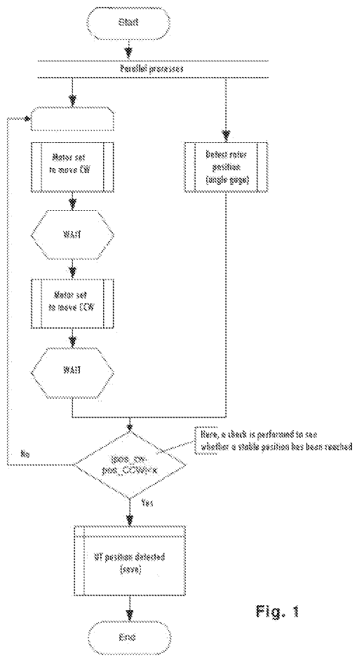

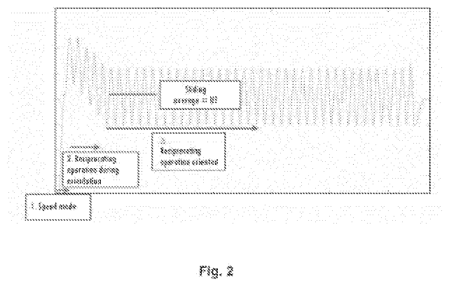

The disclosure will be described in greater detail below based on an exemplary embodiment with reference to FIGS. 1 and 2.

FIG. 1 shows a sample diagram, which represents the angular position of the shaft, beginning with the motor start in speed mode, transitioning into the reciprocating operation; first, an adjustment is made, followed by an adjusted, stable reciprocating operation. The figure also shows the average based on which it is possible to derive the upper reversal point of the diaphragm. The lower reversal point then occurs cyclically in the middle between two successive upper reversal points.

FIG. 2 shows a flowchart with two processes running in parallel. One process relates to the rotor position determination with an angle gage. In parallel with this, the motor is triggered in such a way that it first rotates clockwise (CW), then rotates counterclockwise (CCW), and the process is repeated until a difference for the position in the clockwise direction (pos_cw) and for the position in the counterclockwise direction (pos_ccw) is less than a predetermined set point (X), in order to thus determine that a stable position has been reached. Based on this, the position for the upper turning point (UT) of the diaphragm is then determined.

The turning point is determined by calculating the average between the two reversal points. In other words, the maximum value and minimum value are effectively taken from the rotor position and the average is calculated from them.

The embodiment of the disclosure is not limited to the preferred exemplary embodiments disclosed above. On the contrary, there are a number of conceivable variants that make use of the presented embodiment, even in fundamentally different embodiments.

1. A position detection device for determining a position of a diaphragm or a drive piston of an electric-motor-driven diaphragm pump, including for detecting an upper and lower reversal point in a movement sequence of the diaphragm of the diaphragm pump that is operated in an electric-motor-driven manner via eccentric elements, in which the diaphragm, which is actuated by a drive connecting rod, closes a feed chamber, which is provided with valve elements on the inlet and outlet side such that a volume can be changed between a minimum and maximum volume in that through action of the eccentric elements, a reciprocating motion of an electric motor with a rotor mounted on a shaft being converted into an actuating motion of the drive connecting rod, wherein the position detection device has detection means for detecting an average position of the rotor shaft and has an evaluation device for determining at least the position of the upper reversal point of the diaphragm from the average position.

2. The position detection device according to claim 1, wherein the detection means are configured to detect the average position of the motor shaft during a complete up and down motion of the diaphragm once the motor shaft has been switched from a rotary motion into a reciprocating motion.

3. The position detection device according to claim 2, wherein an angle gage is provided for detecting the rotor position.

4. A diaphragm pump embodied with a position detection device according to claim 1.

5. The diaphragm pump according to claim 4, wherein the diaphragm pump has a motor control device, configured to set the rotor shaft into a reciprocating motion in an angular range between 150° and 200° and has a valve control device for triggering valves as a function of the diaphragm position determined by the position detection device.

6. A method for determining a position of a diaphragm or a drive piston of an electric-motor-driven diaphragm pump, including for detecting an upper and lower reversal point in a movement sequence of the diaphragm of the diaphragm pump that is operated in an electric-motor-driven manner via eccentric elements in which the diaphragm, which is actuated by a drive connecting rod, closes a feed chamber, which is provided with valve elements on the inlet and outlet side such that a volume can be changed between a minimum and maximum volume in that through the action of the eccentric elements, a reciprocating motion of an electric motor with a rotor mounted on a shaft is converted into an actuating motion of the drive connecting rod, wherein the position of the diaphragm is determined based on at least the detection of the average position of the motor shaft through the use of an angle gage.

7. The method according to claim 7 configured with a position detection device according to claim 1.
